(19) United States
(12) Patent Application Publication
(10) Pub. No.: US 2017/0354164 A1
(43) Pub. Date: Dec. 14, 2017

(54) SYSTEM AND METHOD FOR CUSTOM ENGRAVING CHOCOLATE

(71) Applicants: Michael G. Sauvageau, Bethel, CT (US); Jennifer L. Sauvageau, Bethel, CT (US)

(72) Inventors: Michael G. Sauvageau, Bethel, CT (US); Jennifer L. Sauvageau, Bethel, CT (US)

(21) Appl. No.: 15/618,698

(22) Filed: Jun. 9, 2017

Related U.S. Application Data
(60) Provisional application No. 62/348,642, filed on Jun. 10, 2016.

(51) Int. Cl. A23G 1/50

(52) U.S. Cl. CPC A23G 1/50; A23V 2002/00

(57) ABSTRACT

A method of producing a chocolate confection includes selecting a type of chocolate for the chocolate confection, selecting a finished size of the chocolate confection, selecting a design template of the confection, providing a message to be laser engraved onto the chocolate confection, and laser engraving the message and design template directly onto the chocolate confection.

The disclosed embodiments generally relate to providing confections, in particular chocolate confections that are custom engraved.

### BACKGROUND

Presently, creating customized confections requires creating a mold, typically providing one or more specific shapes, embossed or indented with specific patterns, images, messages, or other observable features. A melted combination of ingredients, for example, chocolate, may be poured into the mold to form the customized confection. This process may be disadvantageous because constructing the mold typically requires time, materials, and expenses, and is typically not cost effective for single lot or low volume production of a customized article. In fact, a large number of articles may be required in order to recoup the initial set-up costs.

It would be advantageous to provide an easily customizable confection in a cost effective manner using techniques that overcome these and other disadvantages.

### SUMMARY

The disclosed embodiments are directed to a method of producing a chocolate confection including selecting a type of chocolate for the chocolate confection, selecting a finished size of the chocolate confection, selecting a design template for the confection, providing a message to be laser engraved onto the chocolate confection, and laser engraving the message and design template directly onto the chocolate confection.

Selecting a type of chocolate may include selecting from among a group comprising white chocolate, golden dark chocolate, dark chocolate, and milk chocolate.

Selecting a finished size of the chocolate confection may include selecting from a predetermined set of finished sizes.

Selecting a design template for the confection may include selecting a design template adjusted by adding or removing graphical elements according to the selected finished size of the chocolate confection.

Providing a message to be laser engraved onto the chocolate confection may include providing text for each of an upper section, a center section, and a lower section of the chocolate confection.

Providing a message to be laser engraved onto the chocolate confection may include selecting a font and font size for text to be provided for each of an upper section, a center section, and a lower section of the chocolate confection.

Laser engraving the message and design template directly onto the chocolate confection may include conditioning data related to the selected design template and the message by scheduling engraving to be performed at different locations on the chocolate confection sufficient to allow portions of the chocolate confection to cool between engravings.

Laser engraving the message and design template directly onto the chocolate confection may include conditioning data related to the selected design template by scheduling engraving of proximate graphical elements to be performed at different times sufficient to allow portions of the chocolate confection to cool between engravings.

Laser engraving the message and design template directly onto the chocolate confection may also include conditioning data related to the message by scheduling engraving of proximate text elements to be performed at different times sufficient to allow portions of the chocolate confection to cool between engravings.

Laser engraving the message and design template directly onto the chocolate confection may further include conditioning data related to the selected design template and the message by selecting laser engraving parameters according to the selected type of chocolate.

The disclosed laser engraving process allows for individual customization of messages in chocolate without the setup, artwork and mold fees that present systems require, and allows a user to individually design a chocolate message that gets replicated into a laser engraved chocolate confection.

### BRIEF DESCRIPTION OF THE DRAWINGS

The foregoing aspects and other features of the embodiments are explained in the following description, taken in connection with the accompanying drawings, wherein:

FIG. 1 shows a block diagram of an exemplary system for producing custom confections according to the disclosed embodiments; and

FIG. 2 illustrates a flow diagram of an exemplary process for producing a custom chocolate confection.

### DETAILED DESCRIPTION

The disclosed embodiments are directed to system and method for providing a user with a customized confection, in particular, a custom engraved chocolate confection. Selections may be provided for a type of chocolate, a size of a final chocolate piece, and a decorative design template. A message and payment may then be provided and the decorative design template and message may be laser engraved into a selected chocolate blank to produce a final chocolate piece.

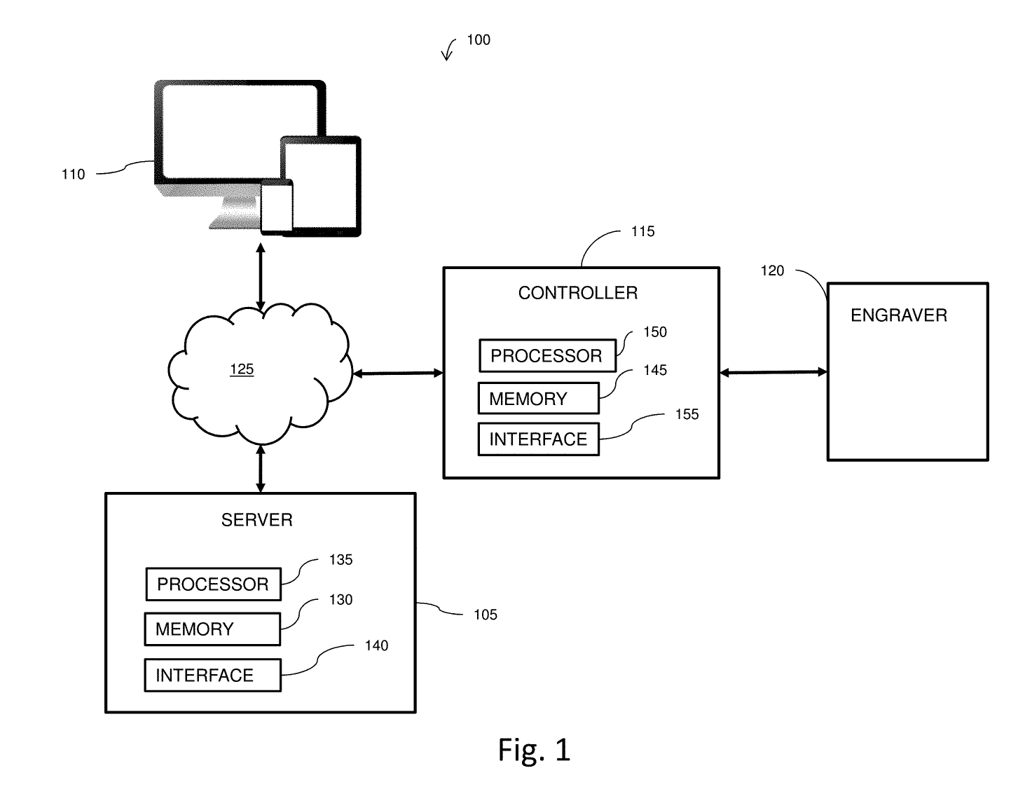

FIG. 1 shows a block diagram of an exemplary system 100 for producing custom confections according to the disclosed embodiments. The system may include a server 105 that may communicate with one or more user devices 110 and a controller 115 coupled to an engraver 120. The server 105, user devices 110, and controller 115 may be connected by a network 125, for example, a local area network, a wide area network, the internet, or any suitable data link, and in some embodiments, may co-located or remotely located from each other. It should be noted that while illustrated as separate entities, the server 105 and the controller 115 may also be implemented in a single device.

The server 105 may include computer readable program code stored on at least one computer readable medium 130 for carrying out and executing the various operations described herein. In particular, the server 105 may include computer readable program code for carrying out and executing exemplary processes for hosting a web site for offering and receiving orders for chocolate confections as described herein, for implementing a payment or shopping cart function, and for providing information associated with the orders to the controller 115 coupled to the engraver 120. The computer readable medium 130 may be a memory of the server 105. In alternate aspects, the computer readable program code may be stored in a memory external to, or remote from, the server 105. The server 105 may also include a microprocessor 135 for executing the computer readable program code stored on the at least one computer readable medium 130. In at least one aspect, the server 105 may include an interface 140 for providing communication among the server 105, the one or more user devices 110, and an operator, if required. A non-limiting example of the server 105 may include one or more servers at specific geographical locations or a distributed cloud service.

A non-limiting example of the one or more user devices 110 may include a personal computer, tablet, mobile phone, or any suitable device for communicating with the server 105. In at least one embodiment, the one or more user devices 110 may provide a user with the ability to interact with the web site provided by the server 105.

The controller 115 may also include computer readable program code stored on a computer readable medium 145 for carrying out and executing various operations including exchanging data with the server and conditioning the information associated with the orders for use by the engraver 120. The server 105 may include a processor 150 for executing the computer readable program code stored on the computer readable medium 145, and an interface 155 for providing communication among the server 105, the engraver 120, and an operator.

The engraver 210 may be a laser engraving device having a laser with variable operating parameters, for example, approximate pulses per inch, approximate beam travel rate, approximate laser power output, and approximate calories delivered per pulse. The engraver may also have other suitable operating parameters.

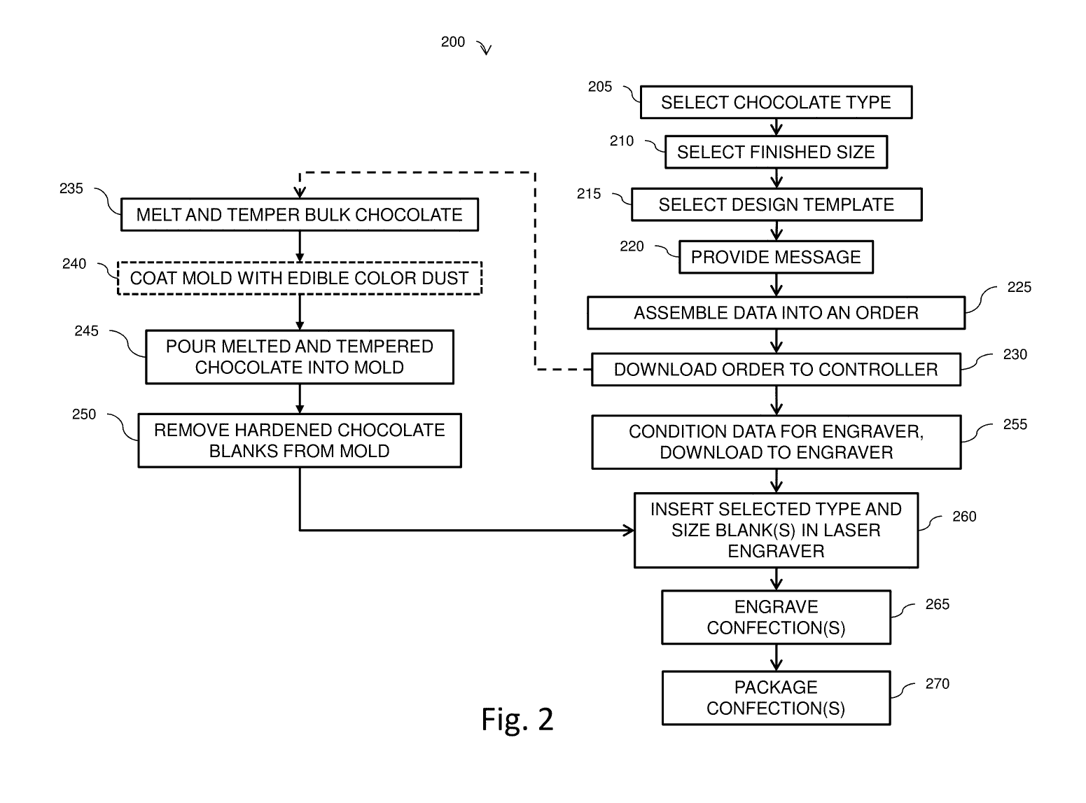

FIG. 2 illustrates a flow diagram of an exemplary process 200 for producing a custom chocolate confection. In some embodiments, one or more portions of the process may be implemented using an HTML form running on the server 105, that presents a custom made design gallery for specifying characteristics of the finished confection.

In block 205, a chocolate flavor or type is selected. Exemplary chocolate types may include white, golden dark, dark, and milk, and may be differentiated by having different ingredients. For example: white chocolate may include sugar, cocoa butter, milk, lactose, sunflower lecithin, and vanilla beans; golden dark chocolate may include cacao beans, sugar, cocoa butter, sunflower lecithin, vanilla beans, and an edible color dust; dark chocolate may include cacao beans, sugar, cocoa butter, sunflower lecithin, and vanilla beans, and milk chocolate may include sugar, milk, cocoa butter, cacao beans, sunflower lecithin, and vanilla beans. While the golden dark chocolate flavor or type is described as including an edible color dust, it should be understood that any flavor or type of chocolate may include an edible color dust as an ingredient.

A finished size of the chocolate confection is selected in block 210. The finished size may be selected from a set of predetermined sizes, or in some embodiments may be user selectable.

In block 215, a design template for the custom chocolate confection may be selected. The design template may include graphical elements, for example, symbols, shapes, lines, line segments, characters, images and other suitable elements. In at least one embodiment, the graphical elements may form a border. The design template may be adjusted based on the selected finished size. In some embodiments, the adjustment may include scaling the size of the design template to fit the selected finished size. In at least one embodiment, the design template may be adjusted by adding graphical elements to the design template, or removing graphical elements from the design template in order to accommodate different finished sizes of the chocolate confection. For example, if the selected finished size is a square, a selected design template may be constructed with a number of graphical elements along each side. If the selected finished size is a rectangle with two sides longer than the square, the selected design template may be constructed with additional graphical elements inserted into the design template on the elongated sides. In an example where the selected finished size is a rectangle with two sides shorter than the square, the design template may be constructed with fewer graphical elements inserted into the design template on the shorter sides. Adding graphical elements to the design template, or removing graphical elements from the design template in order to accommodate the selected finished size may be advantageous because the line width, line length, and sizes of the features of the design template may remain constant, or within certain specifications, avoiding any problems with laser engraving lines and features that may be too small or too large to maintain a proper resolution and visibility. The adjustments described may include only scaling the size of the design template to fit the selected finished size, only adding or removing graphical elements from the design template in order to accommodate the selected finished size, or a combination of scaling the size and adding or removing graphical elements.

In block 220, a message may be provided for the body of the custom chocolate confection. In some embodiments, the message may be divided into different sections, each having a selectable font, font size, and orientation. For example, the body of the chocolate confection may be divided into a top or upper section, a center section, and a bottom or lower section. Text may be provided and a font selection and font size selection may be made individually for each section. In one or more embodiments, fonts may be chosen from a predetermined list, and font sizes may be selected from another predetermined list. In some embodiments, the font list and font size list may be determined by the selected finished size.

Once the selections have been made, data representing the selected chocolate flavor or type, the selected finished size, the selected design template, and the message, may be assembled together as an order, as shown in block 225. The order is then downloaded to the controller 115, as shown in block 230.

Referring to blocks 235, 240, 245, and 250, various chocolate flavors or types may be melted, tempered, poured into molds, allowed to harden into blanks, and the blanks may be removed from the molds for laser engraving. In some embodiments, as shown in block 240, the mold may be coated with an edible colored dust to enhance engraving visibility and to provide a more visually appealing appearance. The process depicted by blocks 235, 240, 245, and 250 may be initiated independently, for example, based on projected inventory requirements, may be initiated as a result of receiving one or more orders downloaded to the controller 115, or may be initiated as a result of some other occurrence or condition. In some embodiments, the process depicted by blocks 235, 240, 245, and 250 may be initiated as a result of receiving an order by the controller 115.

Referring to block 255, order data related to the selected design template and the message may be further conditioned for use by the laser engraver 115. For example, graphical elements of the design template that are proximate, or proximate text elements within the message sections may be scheduled to be engraved at different times, and engraving may be performed at different locations on the blank, sufficient to allow portions of the blank to cool between engravings. Graphical element and text line widths may be changed to enhance resolution and visibility. Further conditioning may also include selecting parameters of the laser engraver according to the selected chocolate flavor or type. The conditioning may be performed to accomplish any combination of: maintaining or enhancing the resolution and visibility of the design template elements and text; preventing blurring of different features of the design template and text; achieving a particular engraving depth; achieving a particular engraving appearance; or achieving any characteristic of the finished piece. Exemplary parameters used for laser engraving are shown in Table 1. It should be understood that these parameters are approximate, and that other parameters and parameter values are also contemplated. As part of the conditioning process, the data may be converted to a vector graphics format before being downloaded to the laser engraver.

TABLE 1

| | | | Approx. | | | |
|---|---|---|---|---|---|---|
| | | | Beam | Laser | Approximate | |
| Type of | | Speed | Travel | Power | Power for 30 W | Approximate |
| Chocolate | Pulses/inch | Setting | Rate | Setting | Laser | kcal/pulse |
| White | 600 | 80% | 48 in/sec | 46% | 13.8 W | 1.14425 E−07 |
| Golden Dark | 600 | 80% | 48 in/sec | 45% | 13.5 W | 1.119375 E−07 |
| Dark | 600 | 80% | 48 in/sec | 44% | 13.2 W | 1.0945 E−07 |
| Milk | 600 | 80% | 48 in/sec | 33% | 9.9 W | 0.820875 E−07 |

As shown in block 260, one or more blanks may be loaded into the laser engraver 115, and may be engraved using the conditioned data, as shown in block 265. Once engraved, the finished confection may be packaged, as shown in block 270.

The disclosed embodiments advantageously provide a method for custom laser engraving design templates and text onto a chocolate confection. Selections may be made among different flavors or types of chocolate, different sizes of the finished confection, different design templates, and custom text having different fonts and sizes. The design templates and custom text may be laser engraved onto selected blanks, providing an efficient method of producing small lot sizes, including lot sizes of one, of customized chocolate confections, without prohibitive set up, artwork, and mold fees found in the present art.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. A method of producing a chocolate confection comprising:
selecting a type of chocolate for the chocolate confection;
selecting a finished size of the chocolate confection;
selecting a design template of the confection;
providing a message to be laser engraved onto the chocolate confection; and
laser engraving the message and design template directly onto the chocolate confection.

2. The method of claim 1, wherein selecting a type of chocolate comprises selecting from among a group comprising white chocolate, golden dark chocolate, dark chocolate, and milk chocolate.

3. The method of claim 1, wherein selecting a finished size of the chocolate confection comprises selecting from a predetermined set of finished sizes.

4. The method of claim 1, wherein selecting a design template of the confection comprises selecting a design template adjusted by adding graphical elements to the design template or removing graphical elements from the design template according to the selected finished size of the chocolate confection.

5. The method of claim 1, wherein providing a message to be laser engraved onto the chocolate confection comprises providing text for each of an upper section, a center section, and a lower section of the chocolate confection.

6. The method of claim 1, wherein providing a message to be laser engraved onto the chocolate confection comprises selecting a font and font size for text to be provided for each of an upper section, a center section, and a lower section of the chocolate confection.

7. The method of claim 1, wherein laser engraving the message and design template directly onto the chocolate confection comprises conditioning data related to the selected design template and the message by scheduling engraving to be performed at different locations on the chocolate confection sufficient to allow portions of the chocolate confection to cool between engravings.

8. The method of claim 1, wherein laser engraving the message and design template directly onto the chocolate confection comprises conditioning data related to the selected design template by scheduling engraving of proximate graphical elements to be performed at different times sufficient to allow portions of the chocolate confection to cool between engravings.

9. The method of claim 1, wherein laser engraving the message and design template directly onto the chocolate confection comprises conditioning data related to the message by scheduling engraving of proximate text elements to be performed at different times sufficient to allow portions of the chocolate confection to cool between engravings.

10. The method of claim 1, wherein laser engraving the message and design template directly onto the chocolate confection comprises conditioning data related to the selected design template and the message by scheduling engraving to be performed at different locations on the chocolate confection sufficient to allow portions of the chocolate confection to cool between engravings.

11. The method of claim 1, wherein laser engraving the message and design template directly onto the chocolate confection comprises conditioning data related to the selected design template and the message by selecting laser engraving parameters according to the selected type of chocolate.
